(19) United States
(12) Patent Application Publication
(10) Pub. No.: US 2009/0037961 A1
(43) Pub. Date: Feb. 5, 2009

(54) ON-DEMAND SYSTEM INTERFACES AND FEATURES

(75) Inventors: DAVID P. GREEN, Castaic, CA (US); CHRIS ROY, Los Angeles, CA (US); ROBERT A. BERGMAN, Redondo Beach, CA (US); SCOTT M. BENOIT, Los Angeles, CA (US); JOY A. ARAI, Palos Verdes Peninsula, CA (US); ERIC J. BENNETT, Los Angeles, CA (US); TYSON L. WINTIBAUGH, Marina del Rey, CA (US); DAVID ERIC SHANKS, Los Angeles, CA (US); TOMMI ITEN, Redondo Beach, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 11/832,511

(22) Filed: Aug. 1, 2007

(51) Int. Cl. H04N 7/173

(52) U.S. Cl. 725/87

(57) ABSTRACT

Broadband system interfaces and features are described. An example includes a user interface for use with a content delivery system including an on-demand service comprising at least one channel dedicated to an on-demand content provider, wherein the channel is accessible in a same manner as a broadcast channel of the content delivery system; and at least one homepage to be presented when a user navigates to the at least one channel, wherein the homepage includes a template of sections to provide a single-level user interface by altering the contents of at least one section in response to an input.

### FIELD OF THE DISCLOSURE

The present disclosure relates generally to content delivery systems and, more particularly, to methods and apparatus to interface with content delivery systems.

### BACKGROUND

Advancements in communication technology have led to enhanced media players (e.g., personal computers, digital video recorders, home media centers, game playing systems, etc.) and content delivery systems (e.g., broadband, satellite, digital cable, Internet, etc.). For example, every improvement in processing capability, for example, allows developers to provide additional functionality to a system. As a result, user interfaces for fairly simple systems may rapidly become more complex.

### BRIEF DESCRIPTION OF THE DRAWINGS

FIG. 1 is a diagram of an example direct-to-home (DTH) transmission and reception system.

FIG. 2 illustrates an example manner of implementing the example integrated receiver/decoder (IRD) of FIG. 1.

FIG. 3 shows an example homepage for an example content delivery system user interface.

FIG. 4A is a screenshot of an example user interface including a program list.

FIG. 4B depicts an example keypad on an example input device.

FIG. 5 is a flow chart representing an example process that may be performed in response to a user selection.

FIG. 6 is a screenshot of an example user interface including a program information area.

FIG. 7 is a screenshot of an example user interface including a trailer viewing area.

FIG. 8 is a screenshot of an example user interface including a queue.

FIG. 9 illustrates an example manner of implementing an example processor unit.

### DETAILED DESCRIPTION

Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

The example methods and apparatus described herein may be used to play, present, and/or interact with audiovisual content in a media presentation system such as, for example, a home entertainment system including a media signal decoder (e.g., a set-top-box, a receiver, etc.) and a television or other media presentation device (e.g., a computer monitor). Moreover, the example interfaces described herein may be implemented to facilitate an interaction between a user and a content delivery system (e.g., a system that delivers on-demand content via a broadband Internet connection).

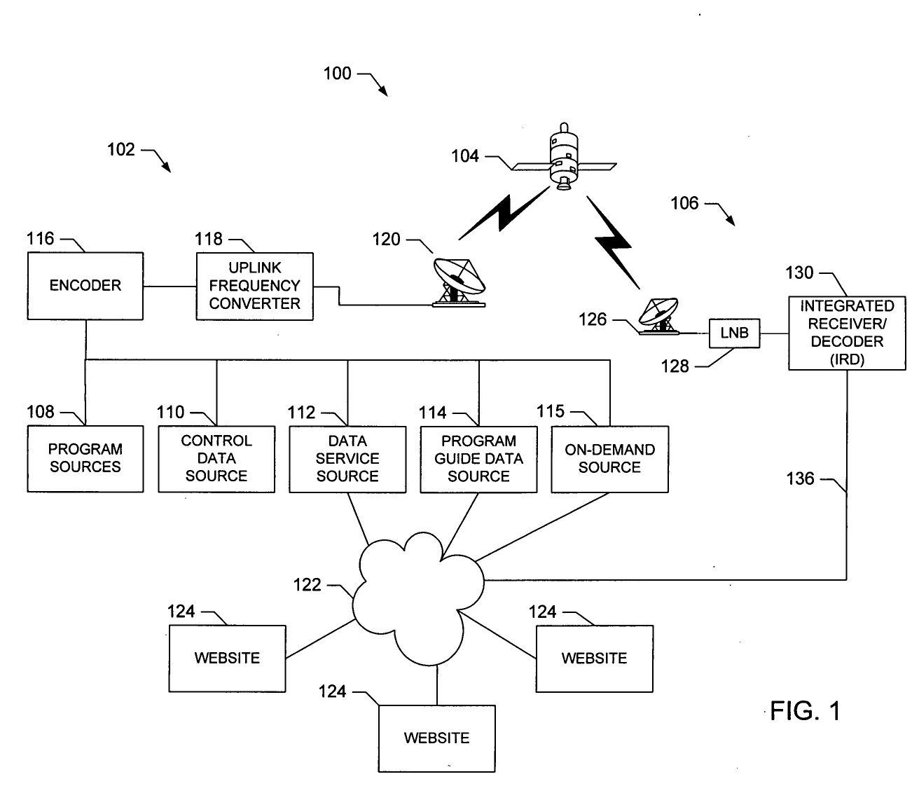

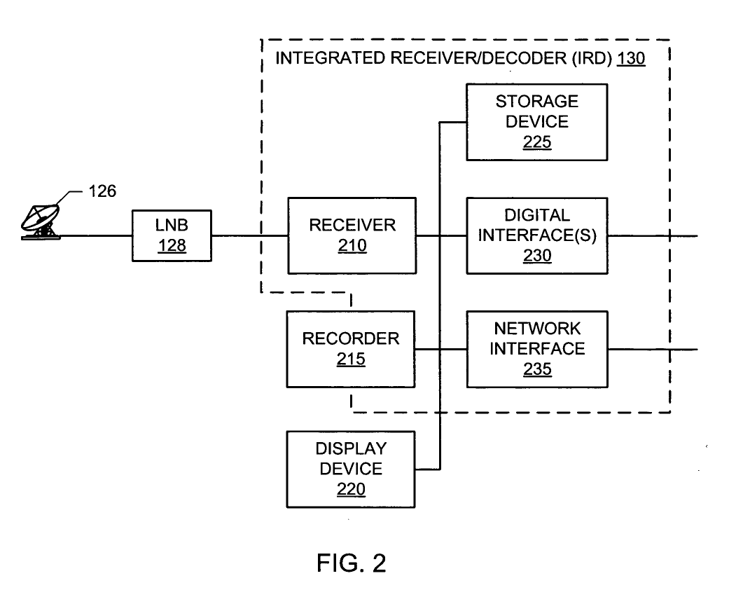

The example methods and apparatus described herein to interact with a content delivery system may be implemented in connection with any type of media transmission system including, for example, satellite broadcast systems, cable broadcast systems, radio frequency wave broadcast systems, broadband transmission systems, etc. By way of illustration, an example broadcast system is described below in connection with FIG. 1 and an example receiver (e.g., a set-top-box, a broadcast signal decoder, etc.) is described in detail below in connection with FIG. 2. Further, while the following disclosure is made with respect to example DIRECTV® services and systems, it should be understood that many other delivery systems are readily applicable to the disclosed methods and apparatus. Such systems include wired or cable distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), and fiber optic networks.

As illustrated in FIG. 1, an example direct-to-home (DTH) system 100 generally includes a transmission station 102, a satellite/relay 104 and a plurality of receiver stations, one of which is shown at reference numeral 106, between which communications are exchanged. Wireless communications (e.g., via the satellite/relay 104) may take place at any suitable frequency, such as, for example, Ku-band frequencies. As described in detail below, information from the transmission station 102 may be transmitted to the satellite/relay 104, which may be at least one geosynchronous or geo-stationary satellite that, in turn, rebroadcasts the information over broad geographical areas on the earth that include receiver stations 106. Further, the receiver stations 106 may be communicatively coupled to the transmission station 102 via a terrestrial communication link, such as a telephone line and/or an Internet connection 136 (e.g., a broadband connection).

In further detail, the example transmission station 102 of the example system of FIG. 1 includes a plurality of sources of data and/or information including program sources 108, a control data source 110, a data service source 112, one or more program guide data sources 114, and an on-demand source 115. In an example operation, information from one or more of these sources 108-115 passes to an encoder 116, which encodes the information for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to an integrated receiver/decoder (IRD) 130. The IRD 130 may be a set-top box, a personal computer (PC) having a receiver card installed therein, or any other suitable device.

In operation of the receiver station 106, the reception antenna 126 receives signals including a bitstream from the satellite/relay 104. The signals are coupled from the reception antenna 126 to the LNB 128, which amplifies and, optionally, downconverts the received signals. The LNB output is then provided to the IRD 130.

The receiver station 106 may also incorporate a connection 136 (e.g., Ethernet circuit or modem for communicating over the Internet) to the network 122 for transmitting requests and other data back to and from the transmission station 102 (or a device managing the transmission station 102 and overall flow of data in the example system 100) and for communicating with websites 124 to obtain information therefrom. For example, as discussed further below, the IRD 130 may acquire and decode on-demand content and/or information associated with on-demand content from the on-demand source 115 via the connection 136 (e.g., a broadband Internet connection).

The programming sources 108 receive video and/or audio programming from a number of sources, including satellites, terrestrial fiber optics, cable, or tape. The programming may include, but is not limited to, television programming, movies, sporting events, news, music or any other desirable content. Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via a network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The program guide data source 114 compiles information related to the SCIDs used by the encoder 116 to encode the data that is broadcast. For example, the program guide data source 114 includes information that the receiver stations 106 use to generate and display a program guide to a user, wherein the program guide may be configured as a grid that informs the user of particular programs that are available on particular channels at particular times. Such a program guide may also include information that the receiver stations 106 use to assemble programming for display to the user. For example, if the user desires to watch a baseball game on his or her receiver station 106, the user will tune to a channel on which the game is offered. The receiver station 106 gathers the SCIDs related to the game, wherein the program guide data source 114 has previously provided to the receiver station 106 a list of SCIDs that correspond to the game. Such a program guide may be manipulated via an input device (e.g., an remote control). For example, a cursor may be moved to highlight a program description within the guide. A user may then select a highlighted program description via the input device to navigate to associated content (e.g., an information screen containing a summary of a television program).

The on-demand (OD) source 115 receives data from a plurality of sources, including, for example, television broadcasting networks, cable networks, system administrators (e.g., providers of the DTH system 100), or other content distributors. Such content may include television programs, sporting events, movies, music, and corresponding information (e.g., user interface information for OD content) for each program or event. The content may be stored (e.g., on a server) at the transmission station 102 or locally (e.g., at a receiver station 106), and may be updated to include, for example, new episodes of television programs, recently released movies, and/or current advertisements for such content. Via a user interface, which also may be updated periodically, a user (e.g., a person with a subscription to an OD service) may request (i.e., demand) programming from the OD source 115. The system 100 may then stream the requested content to the user (e.g., over a broadband Internet connection) or make it available for download and storage (discussed further below in connection with FIG. 2). Thus, an OD service allows a user to view, download, and/or record selected programming at any time. While the acquisition of such content may involve a delay, the term ‘on-demand’ generally refers to a service that allows a user to request and subsequently receive media content. In other words, while on-demand content may not be immediately available, it includes content that may be requested for transmission (e.g., over a broadband Internet connection), download, and/or storage.

FIG. 2 illustrates one example manner of implementing the IRD 130 (e.g., a set-top box) of FIG. 1. The IRD 130 of FIG. 2 is merely an example and other IRD implementations are possible. The LNB output is provided to a receiver 210, which receives, demodulates, de-packetizes, de-multiplexes, decrypts and/or decodes the received signal to provide audio and video signals to a display device 220 (e.g., a television set or computer monitor) and/or a recorder 215. The receiver 210 is responsive to user inputs to, for example, tune to a particular program.

As illustrated in FIG. 2, the recorder 215 may be implemented separately from and/or within the IRD 130. The recorder 215 may be, for example, a device capable of recording information on a storage device 225 (e.g., analog media such as videotape, or computer readable digital media such as a hard disk drive, a digital versatile disc (DVD), a compact disc (CD), flash memory, and/or any other suitable media). The storage device 225 is used to store the packetized assets and/or programs (e.g., a movie requested and transmitted from the OD source 115 over a broadband Internet connection). In particular, the packets stored on the storage device 225 are the same encoded and, optionally, encrypted packets created by the transmission station 102 and transmitted via the satellite/relay 104 or the connection 136.

To communicate with any of a variety of clients, media players, etc., the example IRD 130 includes one or more digital interfaces 230 (e.g., USB, serial port, Firewire, etc.). To communicatively couple the example IRD 130 to, for example, the Internet and/or a home network, the example IRD 130 includes a network interface 235 that implements, for example, an Ethernet interface.

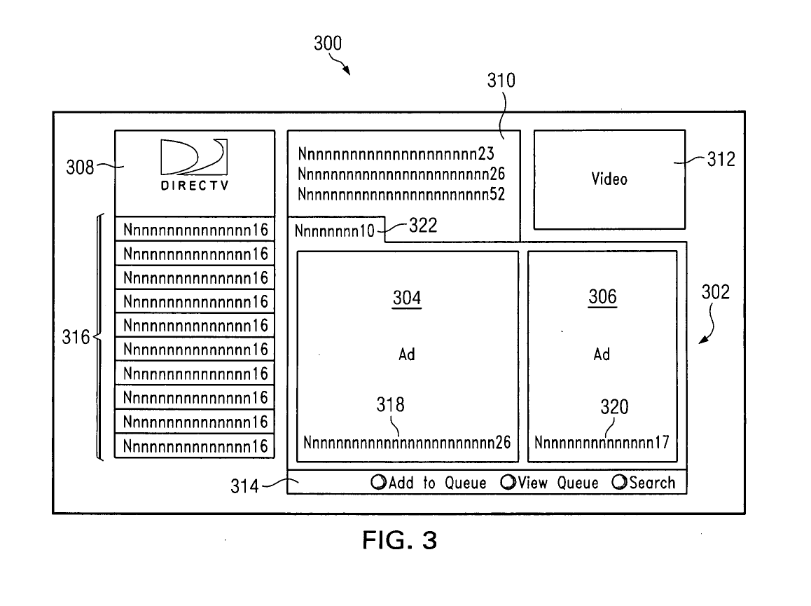

As described above, a program guide and/or user interface may be provided to facilitate an interaction between a user and a content delivery system. For example, to allow the navigation or exploration of the OD source 115 of FIG. 1, a content delivery system may include an on-screen guide or menu to be manipulated through the use of a remote control or other suitable input device. A portion of an example user interface is illustrated in FIG. 3. More specifically, FIG. 3 shows an example homepage 300 to be displayed in connection with an OD service. The homepage 300 may be presented when the user navigates to a designated OD channel (e.g., via a program guide, via another a homepage, by tuning to the OD channel, etc.). In other words, a channel may be dedicated to a content provider (e.g., a television broadcasting station) and the content (e.g., episodes of a television program) it provides to the OD source 115. For example, channels 2-999 may be dedicated to live broadcasts and/or similar streaming data, while channels 1000-1100 may be dedicated to OD content. When a user navigates to channel 1005, for example, the homepage 300 for a television program content provider (e.g., the National Broadcasting Company) may be presented. In one example, an OD channel sequence may be associated or correspond with a broadcast channel sequence (e.g., OD channel 1002 may correspond to the broadcast channel 2). Further, a channel may be dedicated to the content delivery system provider (e.g., DIRECTV®) to present a homepage that acts as a general guide for the OD service. The homepage 300 may be updated to reflect changes in programming, content availability, marketing strategies, etc. For example, the homepage 300 may have a predetermined lifespan (i.e., a scheduled start and stop time), after which the contents of the homepage 300 are replaced.

Existing user interfaces require users to switch modes to interact with an OD source. In contrast, the homepage 300 of FIG. 3 allows a user to navigate to an OD interface in the same manner as a normal broadcast channel (e.g., via a program guide, through another homepage, by tuning to the channel, etc.). Moreover, as described in detail below, the homepage 300 allows live or recorded video (e.g., the channel to which the receiver is currently tuned) to be viewed while the OD interface (e.g., the homepage 300) is displayed. Generally, the homepage 300 is a station with accessibility similar to any other station that represents an OD source (e.g., the OD source 115 of FIG. 1) and facilitates an interaction between a user and the content of the OD source.

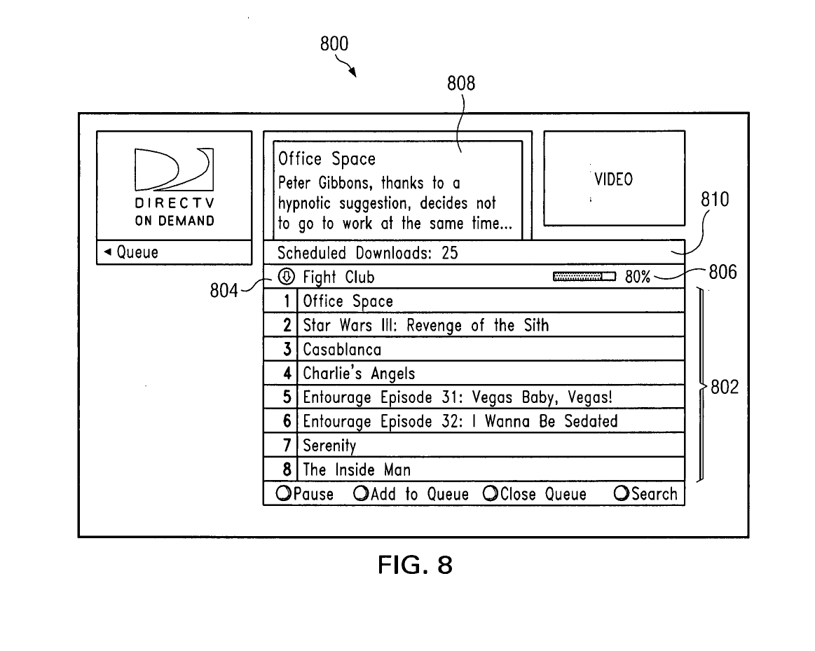

In addition to providing a useful method of navigating through OD content, the homepage 300 may allow a user to manage a queue of downloaded and/or content scheduled to be downloaded on a storage device (e.g., the storage device 225 of FIG. 2). A queue may be provided to aid in the organization of downloads and/or scheduled downloads via, for example, priority settings based on content availability. In one example feature, a user may engage an ‘Add to Queue’ button (discussed further below in connection with FIG. 8) while highlighting a program on the homepage 300. The program may then be scheduled for download immediately or for a later time when the program becomes available. Once downloaded to a storage device, the program may be viewed or managed as any other stored content. The operations associated with the queue may be activated or triggered by a dedicated or dynamic button on a remote input device or by an onscreen button (e.g., a highlighted button on an on-screen guide).

The example homepage 300 includes a template 302 to act as a framework for multiple sections or panels of a display. Unlike prior interfaces, the homepage 300 provides a basis for a single-level interface with sections that may be updated, replaced, resized, or otherwise altered in response to user inputs or system settings (e.g., updates received from the content delivery system provider). In other words, in contrast to layering new windows on top of one another to navigate through content, the individual sections of the template 302 may be manipulated, thereby maintaining a clear, single-level interface. In addition to providing clarity and ease of operation, such an approach allows the content delivery system provider (e.g., DIRECTV®) to control the overall appearance of the homepages (e.g., via the template 302 and/or background) while giving the content providers (e.g., television networks) the ability to insert or overlay their content in the sections of the template 302. Thus, both the content provider of each channel and the content delivery system provider are able to control aspects of the homepage 300 appearance.

The template 302 of FIG. 3 is only one example that may vary in arrangement, shape, number of segments, etc. Such a template may be designed and/or implemented, for example, by the administrators of the content delivery system (e.g., DIRECTV® programmers) or by the content provider to which the associated homepage is dedicated (e.g., a premium cable company). By way of illustration, the example template 302 includes content availability sections 304 and 306, a content provider indicator 308, an information section 310, a video section 312, a button bar 314, a menu 316 and other features discussed below.

The content availability sections 304 and 306 may include, for example, a visual listing (e.g., a poster or banner) for a recently aired television program or a newly released movie. Further, title or label tabs 318 and 320 (discussed further below) may be connected to or placed on the content availability sections 304 and 306 to indicate program or source information. The visual listings, along with a description or title to occupy the tabs 318 and 320, may be supplied by the content provider for that particular homepage 300 and/or a content delivery system provider. For example, a banner for a television program may be disposed in content availability section 304 and may include a tab 318 indicating a season number, an episode number, and/or an episode title. Generally, the sections 304 and 306 convey information regarding the availability or details of a program or other OD content.

While the example template 302 of FIG. 3 shows two content availability sections 304 and 306, another example template may include more or less visual listings of different shapes and sizes. For example, a homepage dedicated to the content delivery system provider may include one large content availability section to present a top pick or a highly rated movie. Such ratings or recommendations may be based on user feedback, awards, viewership statistics, administrative opinions, etc. Additionally or alternatively, the content availability sections 304 and 306 may be occupied by advertisements regarding available or soon to be available OD content. Further, the selection of an advertisement for each content availability section 304 and 306 (e.g., the content availability sections on a homepage dedicated to a content delivery system provider) may be based on a bidding structure, sale, rotation, etc. administrated by, for example, the content delivery system provider.

The content provider indicator 308 may indicate the content provider for the homepage 300 being viewed. For example, the indicator 308 may include a logo to signify what television station provides the content for the OD homepage 300. Further, the content delivery system provider may include its logo (as shown in FIG. 3) when a homepage dedicated to the content delivery system provider is being displayed or when no logo or other indicative graphic is made available by the content provider.

The information section 310 displays information associated with the current homepage 300, a currently highlighted (e.g., in a menu) program, or other similar information associated with OD content.

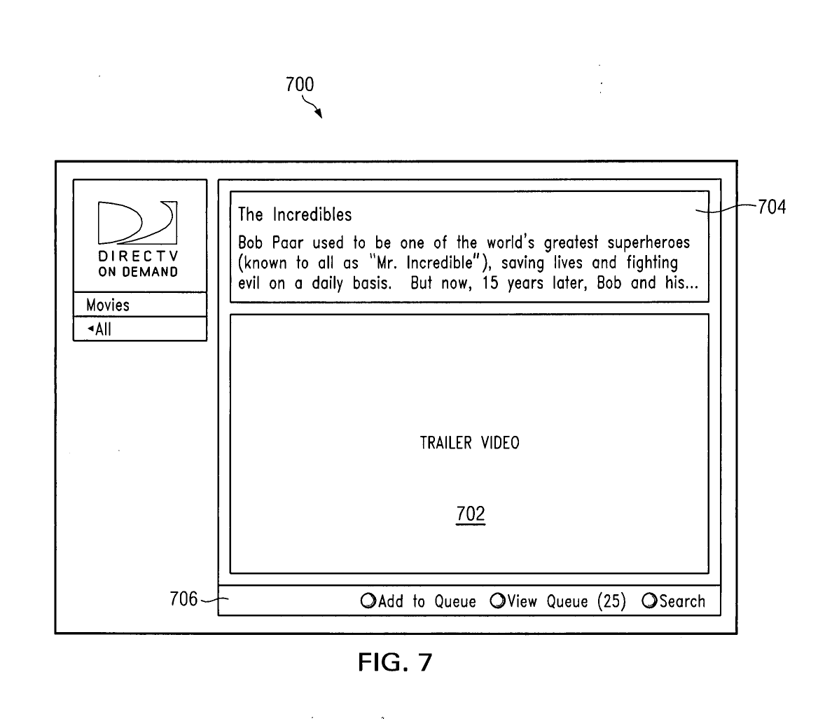

The video section 312 includes a display of the channel to which the system is currently tuned, or the recorded content currently being played back. The video section 312 allows a user to continue viewing broadcast or recorded content while navigating through one or more homepages and/or guides dedicated to the OD service. For example, if a user is viewing a live baseball game and navigates (e.g., in a programming guide or by tuning directly to the OD channel) to a channel dedicated to the OD homepage 300, the video section 312 displays the baseball game as it is broadcast. In another example, if a recording of a movie is currently being played back and a user navigates to the OD homepage 300, the video section 312 displays the recorded movie, allowing the user to simultaneously examine and/or manipulate the OD homepage 300 and watch the recorded content. Additional functionality and options regarding the manipulation of the video section 312 are described below in connection with FIG. 7.

The button bar 314 may include graphics and/or text to indicate an operation corresponding to a button on an input device (e.g., a remote control). For example, the dots shown on the button bar 314 may be different colors to correspond to a same color button on an input device. By way of illustration, the operations shown on the button bar 314 of FIG. 3 are ‘Add to Queue,’ ‘View Queue,’ and ‘Search.’ The corresponding buttons on the input device support a one-touch functionality that allows the same button to be used for multiple one-touch functions (e.g., adding a program to a queue, pausing downloads, searching, etc.). On one screen, a red button may correspond to pausing a program or download session, while the same red button may correspond to adding a program to a queue on another screen. In other words, the button bar 314 may vary from screen to screen, depending on, for example, the content or function of the current screen, thereby allowing a user to activate a relevant feature with one touch of a corresponding button.

As mentioned above, the template 302 may include one or more tabs 318, 320, and 322 within or connected to template sections to label or describe the contents of a section. The description or graphic to occupy the tab may be supplied by the content provider and/or the content delivery system provider. For example, the tab 322 may indicate which episode of a television program is represented by a visual listing (e.g., a banner or poster) within the template 302 and/or whether the program is downloaded, being downloaded, or scheduled for download. Further, the tab 322 connected to the content availability sections 304 and 306 may indicate what type of visual listings is shown. For example, on a homepage dedicated to a content delivery system provider (e.g., the DIRECTV® homepage), the tab 322 may display ‘Top Picks’ to indicate that the visual listings represent recommended programming.

Unlike previous interfaces, the tabs 318, 320, and 322 may be interactive and/or dynamic. In other words, a tabs 318, 320, and 322 may function or be updated separately from the visual listing or section to which the tabs 318, 320, and 320 are connected. For example, where tab 320 includes a graphic or text to indicate that the associated program is currently being downloaded. When the download is complete, the tab 320 may be updated upon download completion to indicate, via a new graphic or text, that the download is complete. The alteration of content of the tabs 318, 320, and 320 may occur without changing the contents of the associated visual listing or section. Further, the tabs 318, 320, and 322 may be selected as an independent object and engaged to direct a user to another screen, to play the associated program, to play a trailer for the associated program, to tune to a channel, etc.

The menu 316 facilitates the navigation of the homepage 300 and/or the OD service in general. The menu 316 may include one or more categories and subcategories representing different filters or options. For example, an ‘All’ category may represent all available OD content. A ‘What's New’ category may include a listing of newly released programs (i.e., programs that were recently made available for download). Additionally, the content delivery system provider (e.g., DIRECTV®) may manage such a category to promote or otherwise emphasize selected newly available programs via, for example, graphics or font treatments of text. A ‘What's Hot’ category may include a listing of recently popular or highly viewed programs. The popularity of content may be based on ratings, user demand, number of downloads, etc. Additionally or alternatively, the contents of a ‘What's Hot’ category may be selected by a content delivery system provider (DIRECTV®) based on an incentive program in which content providers may participate. In other words, content providers may provide compensation to the content delivery system provider in exchange for inclusion in the ‘What's Hot’ category. A ‘Coming Soon’ category may include upcoming programming or programming that will soon be available for download. Such a folder allows the promotion (e.g., by providing program information, advertisements, trailers, etc.) of content that is not yet available. As discussed below in connection with FIG. 8, a program in the ‘Coming Soon’ category may be selected for future download via its addition to a queue. Other non-limiting example categories include Series, Lifestyles, Family and Kids, Special Events, News and Info, and/or More Channels, which allows a user to view other OD homepages. Further, although the categories described herein are discussed as belonging to the example menu 316, a category (e.g., the ‘What's Hot’ category) may be presented elsewhere in the user interface. For example, a homepage may include a section (i.e., a portion of the template 302) dedicated to the content of a ‘What's Hot’ category, a ‘Coming Soon’ category, and/or a ‘What's New’ category.

When a main category is selected the related subcategories may be displayed, for example, in a staggered manner beneath the main category. When selected, the contents of a category or subcategory may be presented on a section of the template 302 (e.g., as a list in one of the content availability sections 304 and 306).

The template 302 discussed above is merely one example of the many possible configurations for an OD homepage. Sections of different sizes, shapes, and/or purposes will be appreciated. Furthermore, the example homepage 300 may provide access to many of the features of an OD service, some of which are discussed below.

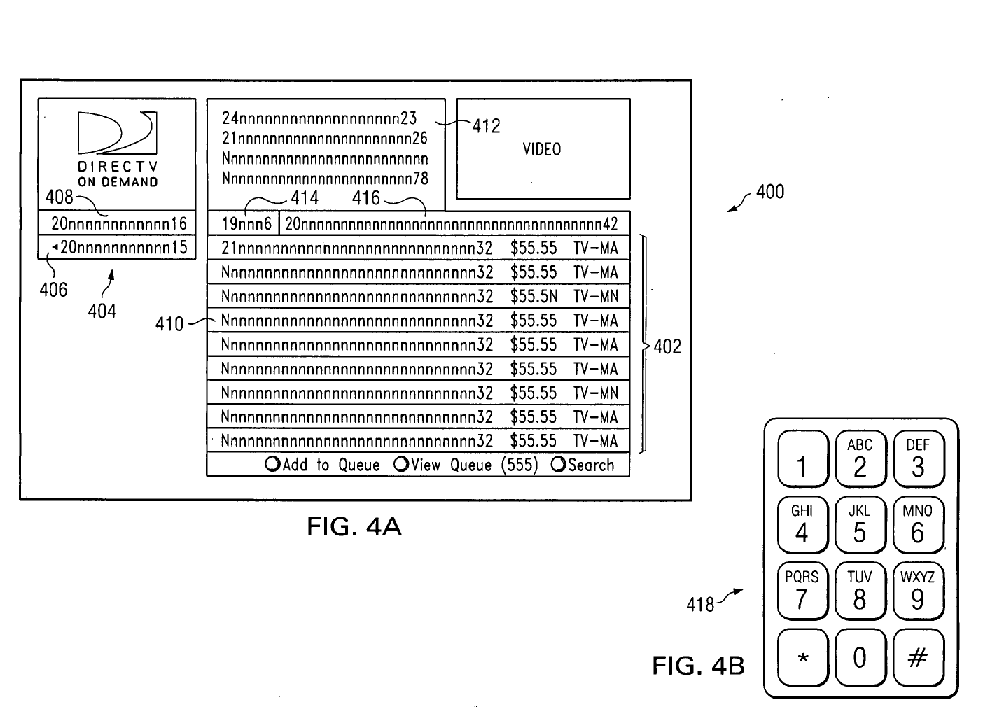

FIG. 4A illustrates an example screenshot 400 to present a list 402 of programs corresponding to, for example, a selected subcategory of a menu (e.g., the menu 316 of FIG. 3). Such a list 402 may also be utilized to present search results. When a user selects a category or subcategory, a compact menu 404 may be displayed to indicate the selection. For example, as illustrated in FIG. 4A a subcategory 406 may be positioned in a staggered format beneath a main category 408. Selecting the subcategory 406 or main category 408 from the compact menu 404 while the list 408 is being displayed may cause the system to return to a previous screen (e.g., the homepage 300 of FIG. 3). Contents of the selected category may be presented as a list 402 in, for example, alphabetical order. The list 402 may contain individual programs and/or a group of programs (e.g., an entire season of a television program). If a user selects a group from the list 402, the individual programs within the group may be presented in a staggered beneath a group title section, similar to the main category 408 and subcategory 406 of the menu 402. When a user navigates to (e.g., highlights using a remote control) a program 410 in the list 402, information about the program 410 may be presented in an information section 412. For example, where the program is a movie, the information section 412 may include a list of starring actors, a genre, and/or a paragraph describing a plot. The correspondence between the information section 412 of FIG. 4A and the information section 310 of FIG. 3 demonstrates how the system maintains a single-level interface by replacing (i.e., updating) sections of a template from screen to screen.

The example screenshot 400 also includes a box 414 to facilitate filtration or searching of the list 402. A bar 416 adjoining the box 414 may include text to instruct the user. For example, the bar 416 may instruct the user to engage a series of keys on an input device to sort the list 402. As shown in FIG. 4B, an input device (e.g., a remote control) may include a numbered keypad 418, wherein the numbers are associated with one or more letters (e.g., the number two is associated with the letters A, B, and C). In an alphabetical list, the programs may be sorted by entering letters into the box 414 via the numbered keypad 418. A ‘triple-click’ function may be used to enter the letters. To utilize the triple-click function, a user presses a button one or more times to choose one of the letters associated with the button. For example, pressing the ‘3’ button on the keypad 418 once, twice, or three times chooses the letter ‘D,’ ‘E,’ or ‘F,’ respectively. By not repeating the engagement of one button for a certain period of time (e.g., a half second), or by pressing a different button, the user selects a first letter to sort the list 402. Once the first letter is selected, the list 402 may scroll up or down to the first program starting with the selected letter. Further, the box 414 may prompt the user (e.g., by moving a cursor to a second position) to enter another letter. If additional sorting is desired, the user may repeat the triple-click process as needed.

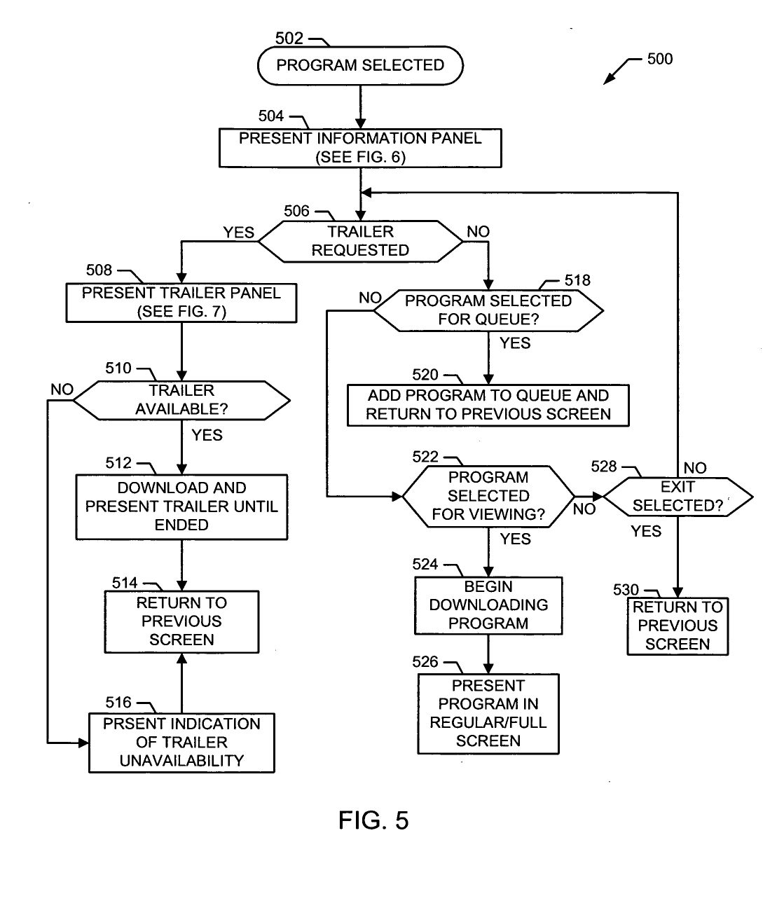

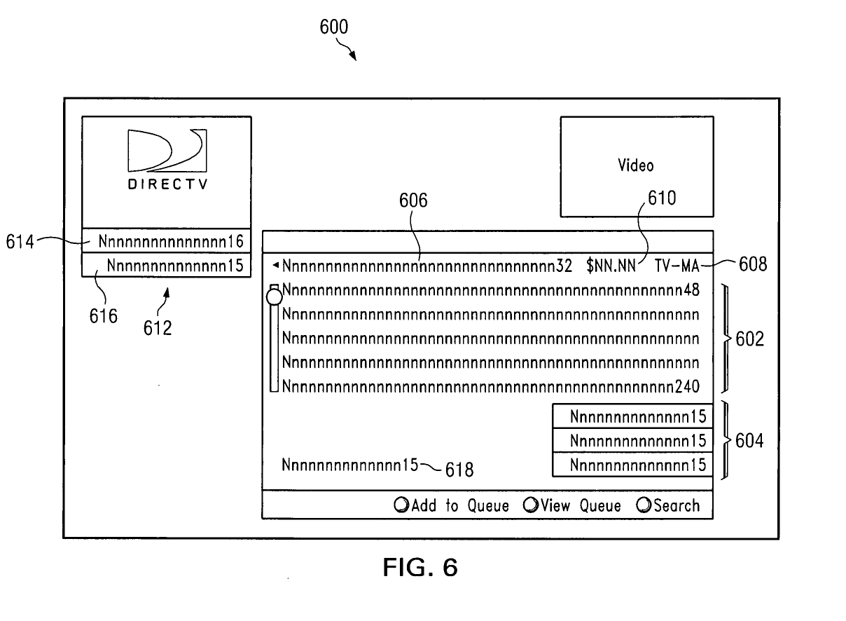

FIG. 5 illustrates an example process 500 that may be performed upon the selection of content on a homepage (e.g., an visual listing on the content availability sections 304 or 306 of FIG. 3) or elsewhere in a program guide, menu, or list (e.g., the list 402 of FIG. 4A). More specifically, when a program is highlighted, or otherwise navigated to, a user may engage one of several options associated with the program. For example, an information panel (discussed further below in connection with FIG. 6) may be presented in response to the engagement of a ‘Select’ or ‘Info’ button. Further, a trailer (discussed further below in connection with FIG. 7), supplied by a content provider, may be presented in response to the engagement of an on-screen ‘Watch Trailer’ button or a ‘Play’ button on an input device. While the process 500 of FIG. 5 demonstrates the operation of an information panel and/or the presentation of a trailer, other features (e.g., a search function) may be triggered by the selection of a program from a homepage, menu, or list.

The process 500 begins with the selection of a program (block 502). An information panel associated with the selected program may then be displayed (block 504). For example, FIG. 6 illustrates an example screenshot 600 to present program information 602 and additional options 604 (discussed below in connection with FIG. 6). Possible non-limiting options may include watching a trailer associated with the program, adding the program to a queue for downloading, and/or viewing the program. The process 500 then determines if one of the options has been selected. For example, where a user has requested a trailer (block 506) a trailer panel is displayed (block 508). FIG. 7 illustrates an example screenshot 700 to present the trailer associated with the selected program. If a trailer is available (block 510), the system downloads and plays the trailer (block 512). When the trailer has ended, the process 500 may then prompt the user to return to the previous screen, present the user with further options, or, as shown in FIG. 5, automatically return to the previous screen (e.g., the information panel from which the trailer was selected). The trailer may end, for example, when the user presses an ‘Exit’ or ‘End’ button, when the entire trailer has been presented, or when the user has otherwise interrupted the trailer. If a trailer is not available at block 510 the process 500 presents an indication of the trailer unavailability (block 516). For example, the content provider may not have supplied a trailer for the program, or the system may be temporarily incapable of downloading a trailer due to other system operations (e.g., a separate download). The process 500 may then prompt the user to return to the previous screen, present the user with further options, or, as shown in FIG. 5, automatically return to the previous screen.

Returning to the decision made at block 506, if a trailer is not requested, the process 500 then determines if the user has selected the program for addition to a queue (discussed below in connection with FIG. 8) (block 518). If, for example, an on-screen ‘Add to Queue’ button is selected or engaged, the program is added to the queue and the process 500 returns to the previous screen (block 520). Otherwise, the process 500 determines whether the program is selected for viewing (block 522). If, for example, a ‘Watch Now’ button is selected or engaged, the program may be downloaded (block 524) and presented on a full screen (i.e., in a normal viewing mode) (block 524). If the user selects or engages an ‘Exit’ button (block 528), for example, before choosing one of the options the process 500 returns to the previous screen (block 530).

The process 500 of FIG. 5 is merely one example of the many possible operations or paths that may be taken upon the selection of a program. For example, when the program is initially selected at block 502, if the program was selected via a ‘Watch Trailer’ button, or other similar dedicated input device, the process 500 may have directly proceeded to download and present an available trailer. Further, when a program is selected to be added to a queue at block 518, the process 500 may have presented a queue screen (e.g., the queue screen of FIG. 8 discussed below) indicating the addition and allowing the user to manage the program within the queue.

As stated above, FIG. 6 illustrates an example screenshot 600 to present information 602 and/or additional options 604 associated with a program. The information 602 (e.g., a summary of television program, movie, or musical performance) may be positioned beneath a title line 606, which may include a rating 608 (e.g., TV-MA to indicate that the program is intended for mature audiences) and/or a cost 610 where the program may be purchased (e.g., a pay-per-view event). Similar to the screenshot 400 of FIG. 4, a menu 612 indicates the category 614 (e.g., ‘Movies’) and/or subcategory 616 (e.g., ‘Comedy’) to which the program belongs. An additional message 618 may also be included to convey, for example, availability information. For example, the message 618 may indicate a last chance date, indicating a last day the program is available for download. In this example screenshot 600, the information section 310 of the template 302 shown in FIG. 3 does not contain any information because the information 602 is presented in another section. Specifically, the information 602 occupies the sections where visual listings (e.g., advertisements in the content availability sections 304 and 306) were positioned in FIG. 3, demonstrating an example of how the sections of the template may be manipulated to maintain a single-level interface.

As stated above, FIG. 7 illustrates an example screenshot 700 to display a trailer associated with a program. If the requested trailer is available for download, the system may present the screenshot 700, for example, during the download or after the download is complete. The trailer may then be presented in a section 702 after download completion or during the download (e.g., once enough content has been downloaded to present the trailer without interruption). Further, an information section 704 may be presented, including, for example, a summary of the program's plot, the release date, cast members, etc. Similar to the screens described above, the screenshot 700 may include a button bar 706 to allow a user to interact with the OD service and the options associated with the trailer (e.g., to add the program to a queue).

Furthermore, where a live broadcast or recording was being presented before playback of the trailer began, the live broadcast or recording may be paused for the duration of the presentation of the trailer screen 700. When the user exits the trailer screen 700 (e.g., by pressing an ‘Exit’ button), the recording may resume playback from the paused position. Alternatively, the live broadcast or recording may resume from the current position after the trailer screen is exited (i.e., the live broadcast or recording may not be paused during the playback of the trailer). Of course, the screenshot 700 is merely an example and alternative implementations may include a video section (e.g., the video section 312 of FIG. 3).

FIG. 8 illustrates an example screenshot 800 to present a queue of downloads and/or scheduled downloads. The example screenshot 800 may be displayed, for example, when a program is selected for future (e.g., where a program is not yet available for download and is selected from a ‘Coming Soon’ category) or immediate (e.g., where a program is available for download) download via one of the options described above (e.g., via an ‘Add to Queue’ button on the button bar 314 or on the information screen 600 of FIG. 6). In this example, the programs of the queue are presented as a list 802, which may be numbered according to position within the queue. The interface allows a user to manage the queue via priority settings, additions or subtractions, moving a program to the top of the queue, etc. For example, a user may a select or highlight a program from the list 802 and engage an arrow on an input device or an on-screen graphic. Alternatively, the user may re-prioritize a program by engaging a numbered button (e.g., a numbered button on the keypad 418 of FIG. 4B) to assign a new priority. For example, a user may highlight the seventh program in the queue and engage the ‘1’ button on an input device, thereby assigning the highlighted program the highest priority (i.e., the highlighted program will be the first downloaded program).

Additionally, the queue includes a feature to allow a user to specify a time during which scheduled downloading may occur. For example, a user may prefer to download queued programs at a time of day when he or she is unlikely to be watching television. Thus, a download session may be delayed and/or scheduled for an afternoon, for example, when the user is at work.

The screenshot 800 also includes a current download bar 804 to indicate which, if any, program is currently being downloaded. Additionally, the current download bar 804 may include a progress bar 806 to indicate how much of the program has been downloaded. As shown in FIG. 8, the progress bar 806 may comprise a graphical representation and/or a textual indication (e.g., a percentage). The progress bar 806 allows the user to determine when a program may be viewed in its entirety without interruption for further downloading. Specifically, since a user may begin viewing a program after only a portion has been downloaded, and since the program may be presented faster than it is downloaded, viewing of a program before a complete download may lead to interruptions or delays. Thus, the progress bar 806 may indicate whether such delays will occur if a user begins viewing the program. By way of illustration, the progress bar 806 may be implemented using three different colors. First, where the progress bar 806 is red, only a small portion of the program has been downloaded and delays will occur shortly after viewing has begun. Second, the progress bar 806 may be yellow to indicate that a significant portion of the program is downloaded and delays may occur late in the program. Finally, a green progress bar 806 may indicate that no delays will occur. In other words, where the progress bar 806 is green, either the entire program has been downloaded or enough of the program has been downloaded so that the presentation will not be delayed.

The screenshot 800 also includes an information section 808 to present a summary, or other suitable information, of the program that is highlighted in the list 802 and a counter section 810 to indicate how many programs are in the queue, a percentage of programs downloaded, and/or whether additional memory exists for more downloads.

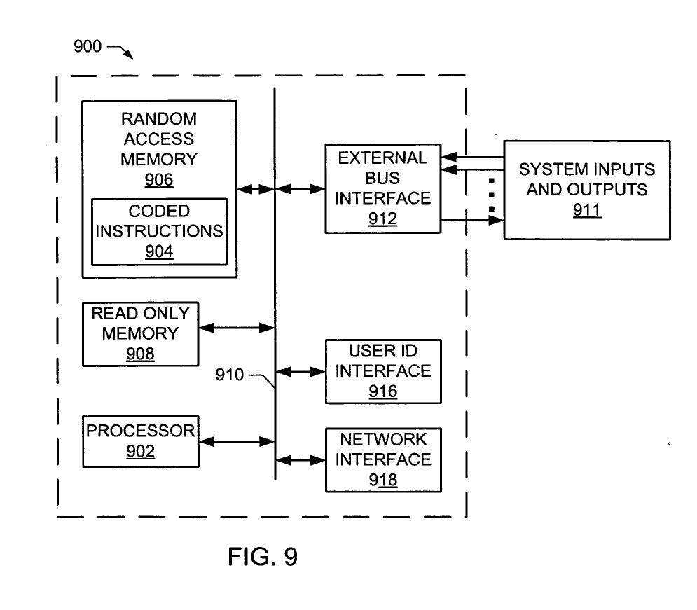

FIG. 9 is a schematic diagram of an example manner of implementing an example processor unit 900 to execute the example methods and apparatus described herein. The example processor unit 900 of FIG. 9 includes a general purpose programmable processor 902. The example processor 902 may execute, among other things, machine accessible instructions 904 (e.g., instructions present within a random access memory (RAM) 906 as illustrated and/or within a read only memory (ROM) 908) to perform the example processes described herein. The example processor 902 may be any type of processing unit, such as a microprocessor from the Intel® Pentium® family of microprocessors, the Intel® Itanium® family of microprocessors, and/or the Intel XScale® family of processors. The processor 902 may include on-board analog-to-digital (A/D) and digital-to-analog (D/A) converters.

The processor 902 may be coupled to an interface, such as a bus 910 to which other components may be interfaced. The example RAM 906 may be implemented by dynamic random access memory (DRAM), Synchronous DRAM (SDRAM), and/or any other type of RAM device, and the example ROM 908 may be implemented by flash memory and/or any other desired type of memory device. Access to the example memories 908 and 906 may be controlled by a memory controller (not shown) in a conventional manner.

To send and/or receive system inputs and/or outputs, the example processor unit 900 includes any variety of conventional interface circuitry such as, for example, an external bus interface 912. For example, the external bus interface 912 may provide one input signal path (e.g., a semiconductor package pin) for each system input. Additionally or alternatively, the external bus interface 912 may implement any variety of time multiplexed interface to receive output signals via fewer input signals.

To allow the example processor unit 900 to interact with a remote server, the example processor unit 900 may include any variety of network interfaces 918 such as, for example, an Ethernet card, a wireless network card, a modem, or any other network interface suitable to connect the processor unit 900 to a network. The network to which the processor unit 900 is connected may be, for example, a local area network (LAN), a wide area network (WAN), the Internet, or any other network. For example, the network could be a home network, an intranet located in a place of business, a closed network linking various locations of a business, or the Internet.

Although an example processor unit 900 has been illustrated in FIG. 9, processor units may be implemented using any of a variety of other and/or additional devices, components, circuits, modules, etc. Further, the devices, components, circuits, modules, elements, etc. illustrated in FIG. 9 may be combined, re-arranged, eliminated and/or implemented in any of a variety of ways.

The apparatus and methods described above are non-limiting examples. Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

Although certain example methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. A user interface for use with a content delivery system including an on-demand service comprising:
at least one channel dedicated to an on-demand content provider, wherein the channel is accessible in a same manner as a broadcast channel of the content delivery system; and
at least one homepage to be presented when a user navigates to the at least one channel, wherein the homepage includes a template of sections to provide a single-level user interface by altering the contents of at least one section in response to an input.

2. A user interface as defined in claim 1, wherein the homepage provides access to on-demand content via interactive sections to be navigated by a user.

3. A user interface as defined in claim 1, wherein a provider of the content delivery system provides the template of sections.

4. A user interface as defined in claim 1, wherein the content provider to which the channel is dedicated provides the content of at least one section.

5. A user interface as defined in claim 1, wherein a section of the template of sections is periodically updated.

6. A user interface as defined in claim 1, wherein a user may navigate to and select a section to activate a feature or to navigate within the user interface.

7. A user interface as defined in claim 1, wherein a section of the template includes video of a currently tuned channel or recorded content currently being played back.

8. A user interface as defined in claim 1, wherein a section of the template includes at least one menu.

9. A user interface as defined in claim 8, wherein menu items are selected to present a list of on-demand programs.

10. A user interface as defined in claim 8, wherein the menu includes at least one category.

11. A user interface as defined in claim 8, wherein the menu includes a category comprising newly available content.

12. A user interface as defined in claim 8, wherein the menu includes a category comprising recommended content.

13. A user interface as defined in claim 8, wherein the menu includes a category comprising content that will available soon.

14. A user interface as defined in claim 1, wherein a section of the template includes a sortable list of on-demand content.

15. A user interface as defined in claim 14, further comprising a triple-click function to sort the list.

16. A user interface as defined in claim 14, wherein the list includes a rating for a program.

17. A user interface as defined in claim 14, wherein the list includes a purchase price for a program.

18. A user interface as defined in claim 1, wherein a section of the template includes an advertisement.

19. A user interface as defined in claim 1, wherein a section of the template includes a source indicator.

20. A user interface as defined in claim 1, wherein a section of the template includes information regarding on-demand content or a content provider.

21. A user interface as defined in claim 1, wherein a section of the template presents a trailer associated with on-demand content.

22. A user interface as defined in claim 1, wherein a section of the template includes information regarding a queue.

23. A user interface as defined in claim 1, wherein a section of the template includes at least one indicator to implement a one-touch function.

24. A user interface as defined in claim 23, wherein the at least one indicator includes a color indication to correspond to a colored button on an input device.

25. A user interface as defined in claim 24, wherein one touch of the colored button on the input device activates an operation corresponding to the at least one indicator.

26. A user interface as defined in claim 1, further comprising at least one label for a section, wherein the label includes information regarding the content of the section.

27. A user interface as defined in claim 26, wherein the label may be navigated to and selected to activate a feature or to navigate within the user interface.

28. A user interface as defined in claim 26, wherein the label indicates a program status or availability of a download.

29. A user interface as defined in claim 1, further comprising at least one homepage dedicated to a provider of the content delivery system.

30. A user interface as defined in claim 29, wherein the homepage dedicated to the provider of the content delivery system includes at least one advertisement.

31. A user interface as defined in claim 29, wherein the at least one advertisement is selected based on a rating or recommendation.

32. A user interface as defined in claim 29, wherein the at least one advertisement is selected based on a bidding system.

33. A user interface as defined in claim 1, wherein a section is selected to add a program to a queue.

34. A user interface as defined in claim 1, wherein a section is selected to present a trailer.

35. A user interface as defined in claim 1, wherein a section is selected to present an information screen.

36. A user interface as defined in claim 1, wherein a section is selected to download a program.

37. A user interface as defined in claim 1, wherein a section is selected to purchase a program.

38. A user interface for use with a content delivery system including an on-demand service comprising:
at least one channel dedicated to an on-demand content provider, wherein the channel is accessible in a same manner as a broadcast channel of the content delivery system;
at least one homepage to be presented when a user navigates to the at least one channel;
a template to provide a single-level interface; and
a plurality of screens implementing the template to facilitate an interaction with on-demand content.

39. A user interface as defined in claim 38, wherein the homepage provides access to on-demand content via interactive sections to be navigated by a user.

40. A user interface as defined in claim 38, further comprising a download queue to manage downloading of on-demand content.

41. A user interface as defined in claim 39, wherein a user restricts downloading to a scheduled download session.

42. A user interface as defined in claim 39, wherein a user may prioritize a download queue entry via an input device.

43. A user interface as defined in claim 39, wherein the plurality of screens includes a queue screen to allow a user to manage the download queue.

44. A user interface as defined in claim 43, further comprising a download progress bar to indicate when a program currently being downloading may be presented without a delay for further download.

45. A user interface as defined in claim 43, wherein the queue screen includes video of a currently tuned channel or recorded content currently being played back.

46. A user interface as defined in claim 43, wherein the queue screen includes information associated with a currently highlighted program.

47. A user interface as defined in claim 43, wherein the queue screen includes at least one indicator to implement a one-touch operation.

48. A user interface as defined in claim 38, wherein the plurality of screens includes a trailer screen to present a trailer associated with on-demand content.

49. A user interface as defined in claim 48, wherein the user interface pauses a currently tuned channel or recorded content currently being viewed when the trailer screen is presented.

50. A user interface as defined in claim 38, wherein the plurality of screens includes a program information screen.

51. A user interface as defined in claim 50, wherein the information screen includes at least one on-screen button to activate a feature associated with the program.

52. A user interface as defined in claim 50, wherein the information screen includes an indication of the availability of the program for download.

53. A user interface as defined in claim 38, wherein the plurality of screens includes a program list screen.

54. A user interface as defined in claim 53, wherein the program list screen includes a sortable program list.

55. A user interface as defined in claim 53, further comprising a triple-click function to sort the program list.

56. A user interface as defined in claim 53, wherein the program list includes a rating for a program.

57. A user interface as defined in claim 53, wherein the program list includes a purchase price for a program.

58. A method of facilitating an interaction with a content delivery system including an on-demand service comprising:
providing a single-level user interface via a template of at least one section;
dedicating at least one channel to a content provider;
receiving content to be placed in the at least one section from the content provider;
altering the at least one section in response to user selections.

59. A method as defined in claim 58, further comprising presenting a homepage when a user navigates to the at least one channel, wherein the homepage provides access to on-demand content via interactive sections to be navigated by a user.

60. A method as defined in claim 58, further comprising dedicating at least one channel to a provider of the content delivery system.

61. A method as defined in claim 58, further comprising scheduling at least one download of on-demand content.

62. A method of managing downloads in an on-demand system comprising:
providing a download queue;
presenting a queue screen via a user interface; and
allowing a user to manipulate the queue via an input device.

63. A method as defined in claim 59, further comprising allowing the user to restrict downloading to a scheduled download session.

64. A method as defined in claim 59, further comprising a download progress bar to be presented on the queue screen.

65. A method as defined in claim 64, wherein the download progress bar indicates when a program may be presented without delay for further downloading.
